(19) United States
(12) Patent Application Publication
(10) Pub. No.: US 2026/0161579 A1
(43) Pub. Date: Jun. 11, 2026

(54) MEMORY BANDWIDTH RESERVATION AND CREDIT-BASED QUALITY OF SERVICE

(71) Applicant: Micron Technology, Inc., Boise, ID (US)

(72) Inventor: Marco Redaelli, München (DE)

(21) Appl. No.: 19/394,173

(22) Filed: Nov. 19, 2025

Related U.S. Application Data
(60) Provisional application No. 63/730,211, filed on Dec. 10, 2024.

(51) Int. Cl. G06F 13/16; G06F 13/18

(52) U.S. Cl. CPC G06F 13/1678; G06F 13/1689; G06F 13/18

(57) ABSTRACT

A computing system includes a memory device and a host device. The memory device includes a memory array including memory cells that are included in one or more memory components, and a memory controller operatively coupled to the one or more memory components. The host device includes a host processor configured to bandwidth requirement of types of memory commands according to read and write bandwidth requirements of the memory commands and to determine a command bandwidth limit based on a reserved bandwidth requirement for the memory device and send the command bandwidth limit and determined bandwidth requirements to the memory controller. The memory controller is configured to perform a memory command when a bandwidth requirement of the memory command is within the command bandwidth limit, and delay performing the memory command when the bandwidth requirement for the memory command exceeds the command bandwidth limit.

### PRIORITY APPLICATION

This application claims the benefit of priority to U.S. Provisional Application Ser. No. 63/730,211, filed Dec. 10, 2024, which is incorporated herein by reference in its entirety.

Embodiments of the disclosure relate to managed memory systems, and more specifically relate to a memory device that ensures minimum read and write performance at the host level of a computing system.

### BACKGROUND

Memory devices are typically provided as internal, semiconductor, integrated circuits in computers or other electronic devices. There are many different types of memory including volatile and non-volatile memory. Volatile memory can require power to maintain data and includes random-access memory (RAM), dynamic random-access memory (DRAM), and synchronous dynamic random-access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random-access memory (RRAM), and magnetoresistive random access memory (MRAM), 3D XPoint™ memory, among others. Memory cells are typically arranged in a matrix or an array. Multiple matrices or arrays can be combined into a memory device, and multiple devices can be combined to form a storage volume of a memory system, such as a solid-state drive (SSD), a Universal Flash Storage (UFS™) device, a MultiMediaCard (MMC) solid-state storage device, an embedded MMC device (eMMC™), etc., as discussed further below. Computing systems may include memory devices and host devices or hosts that communicate data with the memory devices. Data may be communicated between the hosts and memory devices using quality of service (QoS) techniques to improve performance.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example system including a host device and a memory device according to some examples described herein.

FIG. 2 is a block diagram of an apparatus in the form of a memory device according to some examples described herein.

FIG. 3 is a block diagram of memory cells of memory components of a memory device according to some examples described herein.

FIG. 4 is a flow diagram of an example of operating a memory device according to some examples described herein.

FIG. 5 illustrates a block diagram of an example machine according to some examples described herein.

### DETAILED DESCRIPTION

Memory devices can include arrays of memory cells. Managed memory devices can include a memory controller to control or manage access to the memory arrays according to multiple memory management protocols. These protocols may be implemented in firmware installed in the memory controller and can be performed using processing circuitry of the memory controller. The protocols can implement Quality of Service (QoS) techniques to manage communication of data among endpoints of a computer system.

Memory devices include individual memory die, which may, for example, include including a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory dies. Such controller functionality can simplify interoperability with an external device, as a “host” device as discussed later herein. In such managed memory devices, the controller functionality may be implemented on one or more dies also incorporating a memory array, or on a separate die. In other examples, one or more memory devices may be combined with controller functionality to form a solid-state drive (SSD) storage volume.

Embodiments of the present disclosure are described in the example of managed memory devices implementing NAND flash memory cells. These examples can be referred to as managed NAND or mNAND devices. These examples, however, are not limited to the scope of the disclosure, which may be implemented in other forms of memory devices and/or with other forms of storage technology.

Both NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices may be configured and operated in accordance with recognized industry standards. For example, managed NAND devices may be (as non-limiting examples), a Universal Flash Storage (UFS™) device, or an embedded MMC device (eMMC™), etc. For example, in the case of the above examples, UFS devices may be configured in accordance with Joint Electron Device Engineering Council (JEDEC) standards (e.g., JEDEC standard JESD223D, entitled JEDEC UFS Flash Storage 3.0, etc., and/or updates or subsequent versions to such standard. Similarly, identified eMMC devices may be configured in accordance with JEDEC standard JESD84-A51, entitled “JEDEC eMMC standard 5.1”, again, and/or updates or subsequent versions to such standard.

An SSD can be used as, among other things, the main storage device of a computer, having advantages over traditional hard drives with moving parts with respect to, for example, performance, size, weight, ruggedness, operating temperature range, and power consumption. For example, SSDs can have reduced seek time, latency, or other delay associated with magnetic disk drives (e.g., electromechanical, etc.). SSDs use non-volatile memory cells, such as flash memory cells to obviate internal battery supply requirements, thus allowing the drive to be more versatile and compact. Managed memory devices, for example managed NAND devices, can be used as primary or ancillary memory in various forms of electronic devices, and are commonly used in mobile devices.

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory dies, including a number of memory arrays and peripheral circuitry thereon. The flash memory arrays can include a number of blocks of memory cells organized into a number of physical pages. Managed NAND devices can include one or more arrays of volatile and/or nonvolatile memory separate from the NAND storage array, and either within or separate from a controller. Both SSDs and managed NAND devices can receive commands from a host device or host in association with memory operations, such as read or write operations to transfer data (e.g., user data and associated integrity data, such as error data and address data, etc.) between the memory devices and the host, or erase operations to erase data from the memory devices.

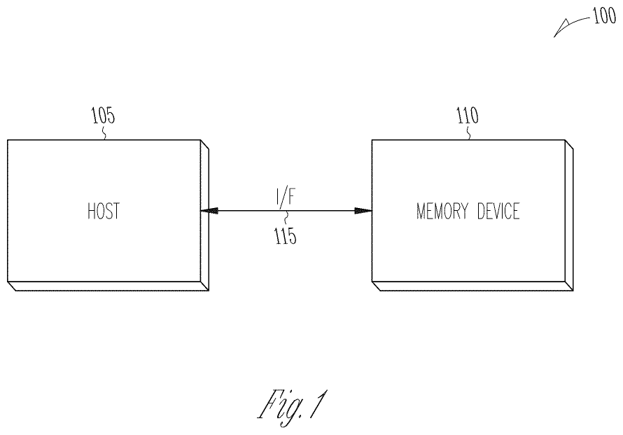

FIG. 1 illustrates an example system 100 including a host device 105 and a memory device 110. The host device 105 can include a host processor, a central processing unit, or one or more other devices, processors, or controllers. The memory device 110 can include one or more other memory components, or the communication interface 115 can include one or more other interfaces, depending on the host device 105 and the memory device 110. Each of the host device 105 and the memory device 110 can include a number of receiver or driver circuits configured to send or receive signals over the communication interface 115, or interface circuits, such as data control units, sampling circuits, or other intermedia circuits configured to process data to be communicated over, or otherwise process data received from the communication interface 115 for use by the host device 105, the memory device 110, or one or more other circuits or devices.

The memory device 110 can include a memory array (e.g., one or more arrays of memory cells, such as a NAND flash memory array, or one or more other memory arrays), a memory controller, and in certain examples, an interface circuit between the memory array and the memory controller. In certain examples, the memory device can include a number of memory die, each having control logic separate from the memory controller. The memory controller can include an application specific integrated circuit (ASIC), a field programmable gate array (FPGA), or one or more other processing circuits arranged or programmed to manage data transfers or operations to, from, or within the memory array.

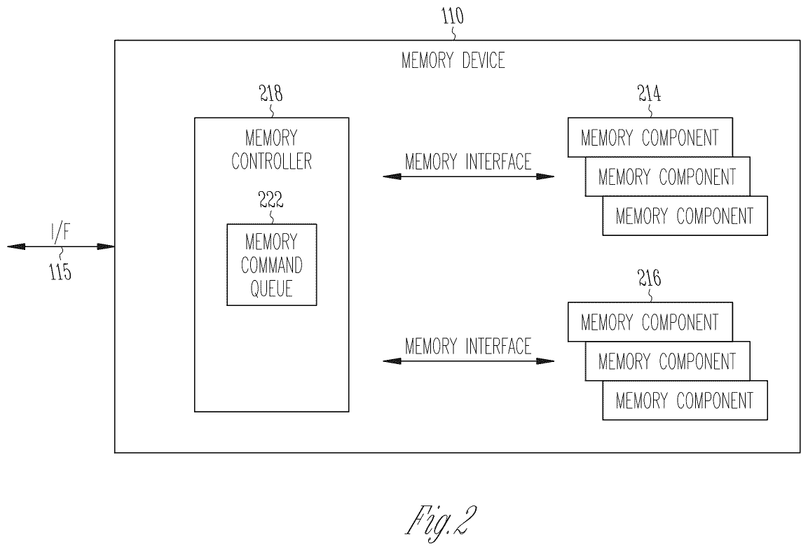

FIG. 2 shows a block diagram of an example memory device 110 suitable for use as memory device 110 in FIG. 1. The memory device 110 can be a managed NAND memory device in which a memory controller 218 is packaged together with memory components 214, 216. In some examples, the memory components 214, 216 include one or more NAND dies. The memory controller 218 can include processing circuitry components such as processor, a state machine (e.g., finite state machine), register circuits, and other components. The memory controller 218 controls memory management functions such as media management and lower level memory management operations such as read, write, and erase operations, program-verify operations, calibrations, etc. of the memory device 110.

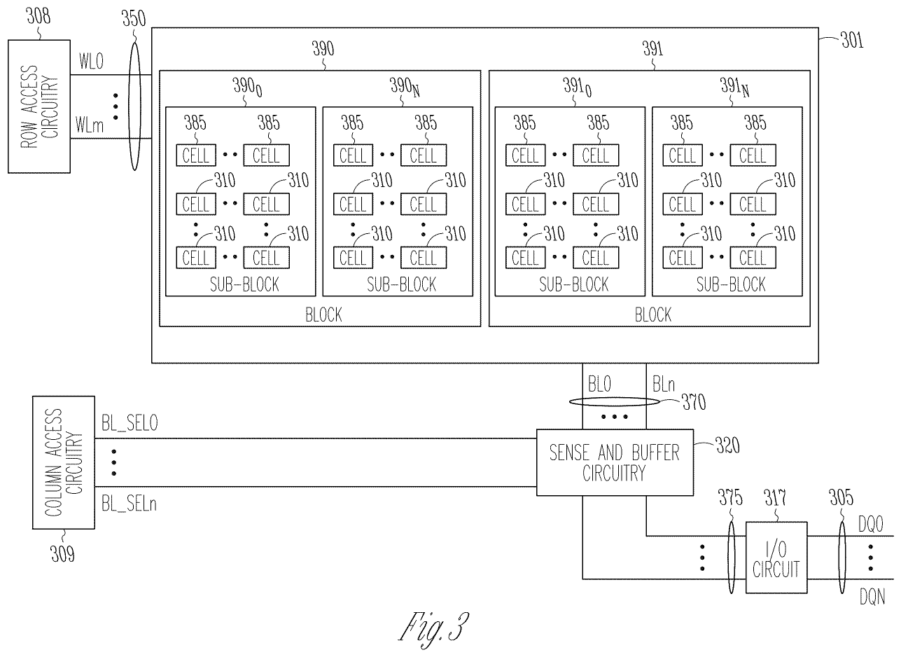

FIG. 3 is a block diagram of memory cells of memory components 214, 216 of memory device 110 in FIG. 2. The memory cells can include non-volatile memory cells having mixed memory cell types integrated in the same integrated circuit (IC) chip, according to some examples described herein. The memory cells are included in a memory array (or multiple memory arrays) 301. The memory array 301 contains memory cells 310 and 385. Memory cells 310 and 385 can be arranged vertically (e.g., stacked over each other) over a substrate of a memory component (e.g., a semiconductor substrate of an IC chip that includes the memory component). Memory cells 310 and 385 can include non-volatile cells. Memory cells 310 and 385 can have different non-volatile memory cell types. For example, memory cells 310 can include floating gate memory cells, charge trap memory cells, or other types of non-volatile memory cells. Memory cells 385 can include ferroelectric memory cells, phase change memory cells, resistive memory cells, conduction bridge memory cells, and spin-transfer-torque magnetic random access memory (STT-MRAM) cells, or other types of non-volatile memory cells.

As shown in FIG. 3, memory cells 310 and 385 can be arranged in blocks (memory cell blocks), such as blocks 390 and 391. Each of blocks 390 and 391 can include sub-blocks. For example, block 390 can include sub-blocks 3900 and 390n, and block 391 can include sub-blocks 3910 and 391n. Each of sub-blocks 3900, 390n, 3910, and 391, can include a combination of memory cells 310 and 385. FIG. 3 shows memory cells arranged in two blocks 390 and 391 and two sub-blocks in each of the blocks as an example. Memory array 301 can have more than two blocks and more than two sub-blocks in each of the blocks.

The memory cells can be included in memory planes. Different portions of a memory die can be referred to as different planes or plane groups (e.g., a group of two or more planes can constitute a plane group) of a same die. In an illustrative example intended to be non-limiting, a memory device may include four memory dies with each die having two planes for a total of eight planes. Commands to the different planes of the same die may execute simultaneously. The memory cells 310 and 385 can be arranged in, for example, a number of devices, semi-conductor dies, planes, sub-blocks, blocks, or pages. More than one plane, sub-block, block, or page can be included on one memory die.

As shown in FIG. 3, access lines can carry signals (e.g., word line signals) WL0 through WLm, and data lines 370 can carry signals (e.g., bit line signals) BLO through BLn. Access lines 350 can be used to selectively access sub-blocks 3900, 390n, 3910, and 391, of blocks 390 and 391 and data lines 370 can be used to selectively exchange information (e.g., data) with memory cells 310 of blocks 390 and 391.

Row access circuitry 308 and column access circuitry 309 can decode address information. Based on decoded address information, it can be determined which memory cells 310 of which sub-blocks of blocks 390 and 391 are to be accessed during a memory operation. A read operation can be performed to read (e.g., sense) information (e.g., previously stored information) in memory cells 310, or a write (e.g., program) operation can be performed to store (e.g., program) information in memory cells 310. Data lines 370 associated with signals BLO through BLn provide information to be stored in memory cells 310 or obtain information read (e.g., sensed) from memory cells 310. An erase operation can be performed to erase information from some or all of memory cells 310 of blocks 390 and 391.

The memory controller 218 in FIG. 2 is configured to control memory operations based on control signals. Examples of the control signals include one or more clock signals and other signals (e.g., a chip enable signal CE #, a write enable signal WE #) to indicate which operation (e.g., read, write, erase operation, erase-verify operation) to perform on the memory array 301.

Sense and buffer circuitry 320 are connected to the memory array 301 that can include sub-components such as sense amplifiers and page buffer circuits (e.g., data latches). Sense and buffer circuitry 320 can respond to signals BL_SEL0 through BL_SELn from column access circuitry 309. Sense and buffer circuitry 320 can be configured to determine (e.g., by sensing) the value of information read from memory cells 310 (e.g., during a read operation) of blocks 390 and 391 and provide the value of the information to lines (e.g., global data lines) 375. Sense and buffer circuitry 320 can also be configured to use signals on lines 375 to determine the value of information to be stored (e.g., programmed) in memory cells 310 of blocks 390 and 391 (e.g., during a write operation) based on the values (e.g., voltage values) of signals on lines 375 (e.g., during a write operation).

Input/output (I/O) circuitry 317 can be connected to the sense and buffer circuitry 320 to exchange information between memory cells 310 of blocks 390 and 391 and lines (e.g., I/O lines) 305. Signals DQ0 through DON on lines 305 can represent information read from or stored in memory cells 310 of blocks 390 and 391. Lines 305 can include nodes within the memory components 314, 316 or pins (or solder balls) on a package where the memory components may reside.

Memory array 301 can receive a supply voltage, including supply voltages Vcc and Vss. Supply voltage Vss can operate at a ground potential (e.g., having a value of approximately zero volts). Supply voltage Vcc can include an external voltage supplied to memory array 301 from an external power source such as a battery or alternating current to direct current (AC-DC) converter circuitry.

Each of memory cells 310 can be programmed individually or collectively to one or a number of programmed states. For example, a single-level cell (SLC) can represent one of two programmed states (e.g., 1 or 0), representing one bit of data. However, flash memory cells can also be multi-level cells (MLCs) that represent one of more than two programmed states, allowing the manufacture of higher density memories without increasing the number of memory cells, as each cell can represent more than one binary digit (e.g., more than one bit).

In another example, each of memory cells 310 can be programmed to store information representing a value for multiple bits, such as one of four possible values “00”, “01”, “10”, and “11” of two bits, one of eight possible values “000”, “001”, “010”, “011”, “100”, “101”, “110”, and “111” of three bits, or one of other values of another number of multiple bits. A cell that has the ability to store multiple bits is sometimes called a multi-level cell (or multi-state cell). MLC is used herein in its broader context, to refer to any memory cell that can store more than one bit of data per cell (i.e., that can represent more than two programmed states, including a triple-level cell (TLC) can refer to a memory cell that can store three bits of data per cell (e.g., one of eight programmed states), and a quad-level cell (QLC) can store four bits of data per cell). The memory controller 218 of FIG. 2 may manage the process of when to program SLC or MLC memory operations.

Memory array 301 can include non-volatile memory, such that memory cells 310 and 385 can retain information stored thereon when power (e.g., voltage Vcc, Vss, or both) is disconnected from the memory component. For example, memory array 301 can include flash memory, such as a NAND flash (e.g., 3-dimensional (3-D) NAND). One of ordinary skill in the art may recognize that a memory component may include other sub-components not shown in FIG. 3 so as not to obscure the example embodiments described herein.

A computing system may utilize QoS techniques to control memory access requests to ensure performance of critical applications or virtual machines (VMs). Performance of the critical applications and VMs may suffer when memory accesses reach the bandwidth limitations of the memory interface. Reaching the bandwidth limitation can cause critical applications and VMs to stall or freeze. An improved approach is to use QoS techniques that ensure that a minimum read and write performance is available at the host level.

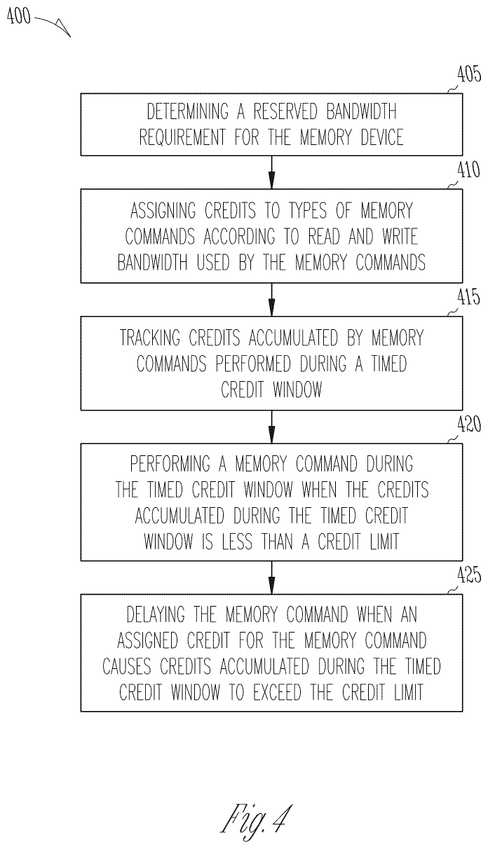

FIG. 4 is a flow diagram of an example of a method operating a computing system that includes one or more host devices 105 and one or more memory devices 110. The method 400 involves a QoS approach that reserves a minimum bandwidth at the memory NAND level. The technique guarantees an independently defined minimum read performance and write performance at the host level through automated estimation and reservation of NAND-level bandwidth. This optimization minimizes performance fluctuations and enhances overall reliability of the system.

At block 405, a host processor of a host device 105 of the computing system determines a reserved bandwidth requirement for the data communication with the memory device 110 of the computing system. The reserved bandwidth requirement may be the minimum bandwidth that ensures that the critical applications running on the host device 105 will have some minimum read and write access. The host device 105 may begin by estimating the overall read and write bandwidth available at the NAND level of the memory device. The reserved bandwidth requirement (e.g., measured in Megabytes per second or MB/s) is a fraction of the estimated overall bandwidth of the memory device. The reserved bandwidth requirement is less than the average bandwidth used by the system. For example, the reserved bandwidth requirement may be ten percent (10%) of the estimated overall bandwidth.

At block 410, the host device 105 determines bandwidth requirements and assigns credits to memory commands from the host device 105 that are sent to the memory device 110. Each memory command is assigned a specific number of credits based on read and write bandwidth requirements of the command. In some examples, the host device 105 determines application layer bandwidth requirements, and allocates credits to memory commands using the application layer bandwidth requirements and the bandwidth capability of the memory device 110. A value of assigned credit may have the same units as the reserved bandwidth (e.g., a number of MB/s). Different types of host memory commands may be assigned different values of credit. The credit assigned to a read command or write command may specify the minimum read or write bandwidth required for specific tasks or logical units (LUs). For instance, the credit assigned to a read command for an LU running the Linux operating system (OS) may be the minimum bandwidth needed for the Linux read command, and the credit assigned to a Linux write command may be the minimum bandwidth needed for the Linux write command. Similarly, the credit assigned to a read command for an LU running Windows may be the minimum bandwidth needed for the Windows read command, and the credit assigned to a Windows write command may be the minimum bandwidth needed for the Windows write command.

Memory commands that use more of the available bandwidth may be assigned higher credit values. This credit system is used to manage the allocation of bandwidth to the different host memory commands and ensures that all commands have fair access to the available bandwidth. Internal memory maintenance operations (e.g., internal flash translation layer (FTL) housekeeping operations) may also be included in assigning the credit. Including the FTL operations in the credit assignment accounts for the interplay between the host memory commands and the FTL algorithms to ensure minimum read and write performance. FTL operations can be used in the credit assignment process by computing a moving average of credits used over a specified time window (e.g., a one second window). This moving average can provide insight into the effect of internal data movement and internal management processes on the overall bandwidth needs. The credit assignments are provided to the memory controller 218 of the memory device 110. The host device 105 may calculate a value of available credit using the minimum bandwidth requirement and an available bandwidth of the memory system. The host device 105 may abort the assigning credit operation with an error when the credits assigned to memory commands exceeds the calculated available credit.

At block 415, the memory controller 218 tracks credits accumulated by the memory commands from the host device 105. The accumulated credit total is a measure of the bandwidth used by the memory commands. In some examples, the memory controller 218 tracks credits accumulated by the memory commands performed during a timed credit window. The timed credit window may be the same as the moving average time window (e.g., a one second credit window). The memory controller 218 compares the accumulated credit total against a predetermined credit limit that may be a memory command bandwidth limit. The memory controller 218 may receive the credit limit from the host device or may derive the credit limit using the reserved bandwidth requirement. For instance, the host device 105 may subtract the reserved bandwidth requirement from the overall bandwidth to determine the credit limit. This sets the credit limit to the amount of bandwidth that can be used up until impacting the reserved bandwidth requirement. In certain examples, the credit limit is set to a threshold before the reserved bandwidth requirement is impacted. In another example, the host device 105 sends the reserved bandwidth requirement to the memory controller 218 and the memory controller 218 determines the credit limit. In a further example, the host device 105 uses the calculated available credit as the credit limit.

At block 420, the memory controller 218 performs a host memory command when the accumulated credit including the credit assigned to the host memory command is less than or equal to the credit limit. At block 425, the memory controller 218 delays a host memory command when the assigned credit of the host memory command would result in the accumulated credit exceeding the credit limit. The memory device 110 may include one more memory command queues 222.

The memory controller 218 may delay performing the memory command by queuing the memory command until there is sufficient credit available to perform the memory command. In some examples, the memory controller 218 may recurrently initiate timed credit windows and may accumulate credits for each credit window. The credit count may be reset each credit window. If memory commands are queued because their assigned credit is too high for the current credit window, the memory controller 218 delays performing the queued memory commands until a subsequent credit window is initiated. In some examples, the credit assigned to a memory command expires if the memory command is not performed after a specified number of timed credit windows. A memory command with expired credit may be reassigned a new credit and the memory command is retried.

In some examples, a host device 105 determines a reserved memory read bandwidth and a reserved memory write bandwidth. A read credit limit and a separate write credit limit are determined. The memory controller 218 tracks a separate read credit for memory read commands and a separate write credit for memory write commands. The memory controller 218 delays a memory read command when an assigned credit for the memory read command would exceed the read credit limit, and delays a memory write command when an assigned credit for the memory write command would exceed the write credit limit.

According to some examples, the host device 105 only assigns credit to memory commands of the critical applications of the host device 105 and other memory commands may not be assigned a credit. The memory controller 218 may perform memory commands with a credit with a higher priority than commands that do not have an assigned credit. The memory controller 218 performs memory commands with assigned credit first. If there is unused bandwidth available after performing memory commands that are assigned a credit, the memory controller 218 may perform the other memory commands that are not assigned a credit using another scheduling policy such as round robin scheduling.

As explained previously herein, the reserved bandwidth requirement is a fraction of the overall available bandwidth of the memory device (e.g., 10% of the overall available bandwidth) and is less than the average bandwidth used by the system. This ensures scheduling of the memory commands that are not assigned credit unless the bandwidth of the computer system reduces to the reserved bandwidth. The memory controller 218 may manage and monitor the credit scheduling policy and the other policy separately. For instance, the memory controller 218 may manage the round robin scheduling of commands separate from the credit-based scheduling of commands. The round robin scheduling ensures that an average bandwidth distribution for memory commands and the credit-based scheduling enforces the minimum guaranteed bandwidth for specific applications and VMs. The memory controller 218 may schedule internal FTL housekeeping operations (e.g., garbage collection to free up memory space) with the credit-based scheduling or may assign a priority to FTL operations that is lower than the assigned credit memory commands and higher than the non-credit assigned memory commands. This allows FTL operations to be performed right after the credit-based commands and before the other round robin scheduled commands are performed.

The methods, devices, and systems described herein can improve performance of a computer system. The bandwidth reservation and credit-based QoS approach optimizes data transfers, minimizes performance fluctuations, and ensures efficient resource utilization. This results in enhanced overall performance of memory devices such as non-volatile memory sold-state drives (NVMe SSDs), making them suitable for a wide range of applications. A minimum read and write performance can be guaranteed independently and the credit-based QoS approach considers both host commands and the internal FTL operations. This enhances the reliability and stability of NVMe SSDs even during heavy workloads. The integration of the bandwidth reservation and credit-based QoS with an existing NVMe queue management ensures smooth operation without disrupting standard NVMe SSD functionalities. The credit-based QoS allows for fair and efficient resource allocation, avoiding underutilization of bandwidth during low-demand periods while maintaining a guaranteed minimum read and write performance during high-demand periods.

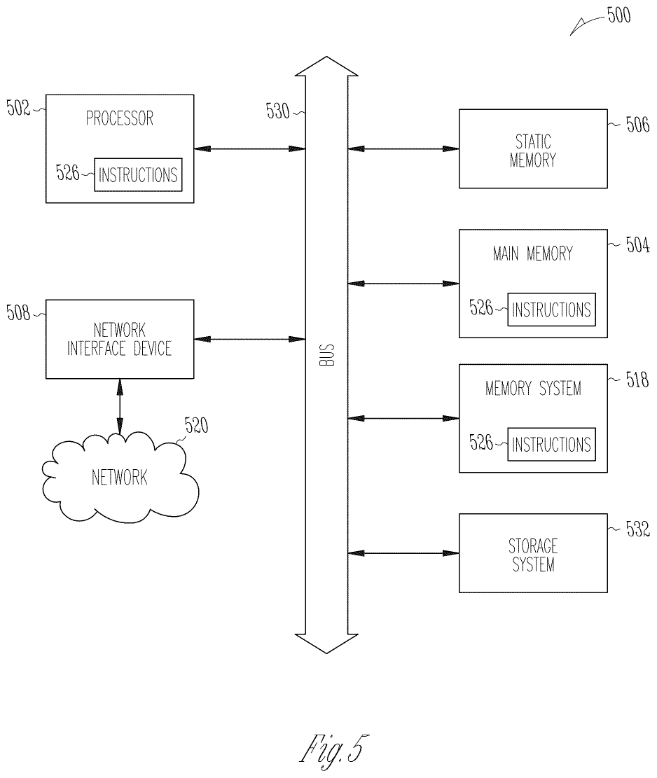

FIG. 5 illustrates a block diagram of an example machine 500 (e.g., a host system) upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in a peer-to-peer (P2P) (or other distributed) network environment. The machine 500 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 500 (e.g., computer system, a host system, etc.) may include a processing device 502 (e.g., a hardware processor, a central processing unit (CPU), a graphics processing unit (GPU), a hardware processor core, or any combination thereof, etc.), a main memory 504 (e.g., read-only memory (ROM), dynamic random-access memory (DRAM) such as synchronous DRAM (SDRAM) or Rambus DRAM (RDRAM), etc.), a static memory 506 (e.g., static random-access memory (SRAM), etc.), a memory system 518, and a storage system 532, some or all of which may communicate with each other via a communication interface (e.g., a bus) 530.

The processing device 502 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 can be configured to execute instructions 526 for performing the operations and steps discussed herein. The computer system can further include a network interface device 508 to communicate over a network 520.

The memory system 510 can include a machine-readable storage medium (also known as a computer-readable medium) on which is stored one or more sets of instructions 526 or software embodying any one or more of the methodologies or functions described herein. The instructions 526 can also reside, completely or at least partially, within the main memory 504 or within the processing device 502 during execution thereof by the computer system, the main memory 504 and the processing device 502 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 500 may further include a display unit, an alphanumeric input device (e.g., a keyboard), and a user interface (UI) navigation device (e.g., a mouse). In an example, one or more of the display units, the input device, or the UI navigation device may be a touch screen display. The machine may include a signal generation device (e.g., a speaker), or one or more sensors, such as a global positioning system (GPS) sensor, compass, accelerometer, or one or more other sensors. The machine 500 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 526 (e.g., software, programs, an operating system (OS), etc.) or other data stored on the storage system 518 can be accessed by the main memory 504 for use by the processing device 502. The main memory 504 (e.g., DRAM) is typically fast, but volatile, and thus a different type of storage than the storage system 518 (e.g., an SSD), which is suitable for long-term storage, including while in an “off” condition. The instructions 526 or data in use by a user or the machine 500 are typically loaded in the main memory 504 for use by the processing device 502. When the main memory 504 is full, virtual space from the memory system 518 can be allocated to supplement the main memory 504; however, because the memory system 518 device is typically slower than the main memory 504, and write speeds are typically at least twice as slow as read speeds, use of virtual memory can greatly reduce user experience due to storage system latency (in contrast to the main memory 504, e.g., DRAM). Further, use of the storage system 518 for virtual memory can greatly reduce the usable lifespan of the storage system 518.

The instructions 524 may further be transmitted or received over a network 520 using a transmission medium via the network interface device 508 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 508 may include one or more physical jacks (e.g., Ethernet, coaxial, or phone jacks) or one or more antennas to connect to the network 520. In an example, the network interface device 508 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, unless stated otherwise the term “or” is used to refer to a nonexclusive or, such that “A or B” may include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended. A system, device, article, or process that includes elements in addition to those listed after such a term in a claim are still deemed to fall within the scope of that claim. Moreover, in the following claims, the terms “first,” '7 second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” (in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

As used herein, directional adjectives, such as horizontal, vertical, normal, parallel, perpendicular, etc., can refer to relative orientations, and are not intended to require strict adherence to specific geometric properties, unless otherwise noted. For example, as used herein, a vertical structure need not be strictly perpendicular to a surface of a substrate but may instead be generally perpendicular to the surface of the substrate, and may form an acute angle with the surface of the substrate (e.g., between 60 and 120 degrees, etc.)

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory controller (e.g., a processor, controller, firmware, etc.) located internal or external to a memory device, is capable of determining (e.g., selecting, setting, adjusting, computing, changing, clearing, communicating, adapting, deriving, defining, utilizing, modifying, applying, etc.) an amount of credit assigned to a memory command. According to one or more embodiments of the present disclosure, a memory access device may be configured to perform the memory operation according to the amount of credit and a credit limit for memory operations.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine, device, or computer-implemented at least in part. Some examples can include a computer-readable medium, a device-readable medium, or a machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact discs and digital video disks), magnetic cassettes, memory cards or sticks, random access memories (RAMs), read only memories (ROMs), solid state drives (SSDs), Universal Flash Storage (UFS) device, embedded MMC (eMMC) device, and the like.

Example 1 includes subject matter (such as a computer system) comprising a memory device and a host device. The memory device includes a memory array including memory cells that are included in one or more memory components and a memory controller operatively coupled to the one or more memory components. The host device includes a host processor configured to determine bandwidth requirements of types of memory commands according to read and write bandwidth requirements of the memory commands and determine a command bandwidth limit based on a reserved bandwidth requirement for the memory device and send the command bandwidth limit and determined bandwidth requirements to the memory controller. The memory controller is configured to perform a memory command when a bandwidth requirement of the memory command is within the command bandwidth limit and delay performing the memory command when the bandwidth requirement for the memory command exceeds the command bandwidth limit.

In Example 2, the subject matter of Example 1 optionally includes a host processor configured to assign credits to types of memory commands according to the read and write bandwidth requirements of the memory commands; determine a credit limit based on the reserved bandwidth requirement for the memory device and send the credit limit and assigned credits to the memory controller; and optionally includes a memory controller configured to perform a memory command when an assigned credit of the memory command is within the credit limit; and delay performing the memory command when the assigned credit for the memory command exceeds the credit limit.

In Example 3, the subject matter of Example 2 optionally includes a memory controller configured to accumulate credits of memory commands performed during a timed credit window, perform a memory command during the timed credit window when the accumulated credits during the timed credit window are less than the credit limit, and delay performing the memory command when an assigned credit for the memory command would cause credits accumulated during the timed credit window to exceed the credit limit.

In Example 4, the subject matter of Example 3 optionally includes at least one memory command queue included in the memory device and a memory controller configured to set the accumulated credits to zero when a new timed credit window begins, and delay performing the memory command by queuing the memory command until a subsequent timed credit window begins.

In Example 5, the subject matter of one or both of Examples 3 and 4 optionally includes a memory controller configured to schedule performing the memory commands during the timed credit window according to the assigned credits when the memory commands have assigned credit, and schedule performing the memory commands according to round robin scheduling during the timed credit window when credit is unused during the timed credit window.

In Example 6, the subject matter of one or any combination of Examples 2-5 optionally includes a host processor configured to set the credit limit to less than or equal to the reserved bandwidth requirement for the memory system, and assign a credit to a type of memory command that is a fraction of an available bandwidth of the memory system.

In Example 7, the subject matter of one or any combination of Examples 2-6 optionally includes a host processor configured to include a maintenance bandwidth of memory maintenance operations in the determined reserved bandwidth requirement.

In Example 8, the subject matter of one or any combination of Examples 2-7 optionally includes a host processor configured to determine a reserved memory read bandwidth requirement and determine a read credit limit according to the reserved memory read bandwidth requirement and determine a reserved memory write bandwidth requirement and determine a write credit limit according to the reserved memory write bandwidth requirement, and optionally includes a memory controller configured to delay a memory read command when an assigned credit for the memory read command would exceed the read credit limit, and delay a memory write command when an assigned credit for the memory write command would exceed the write credit limit.

In Example 9, the subject matter of one or any combination of Examples 2-8 optionally includes a memory controller configured to perform memory commands that are assigned credit with a higher priority than memory commands that are not assigned credit.

In Example 10, the subject matter of one or any combination of Examples 2-9 optionally includes a host device configured to determine application layer bandwidth requirements, and allocate the credits to memory commands using the application layer bandwidth requirements and a bandwidth capability of the memory device.

Example 11 includes subject matter (such as a method of operating a computing system) or can optionally be combined with one or any combination of Examples 1-10 to include such subject matter, comprising determining, by a host device of the computing system, a reserved bandwidth requirement for a memory device of the computing system; assigning credits to types of memory commands according to read and write bandwidth used by the memory commands; tracking, by a memory controller of the memory device, credits accumulated by memory commands performed during a timed credit window; performing a memory command during the timed credit window when the credits accumulated during the timed credit window is less than a credit limit, wherein the credit limit is determined according to the reserved bandwidth requirement; and delaying the memory command when an assigned credit for the memory command causes the credits accumulated during the timed credit window to exceed the credit limit.

In Example 12, the subject matter of Example 11 optionally includes setting the credit limit to less than or equal to the reserved bandwidth requirement for the memory device, and assigning a credit that is a fraction of an available bandwidth of the memory device.

In Example 13, the subject matter of one or both of Examples 11 and 12 optionally includes determining the reserved bandwidth requirement to include a maintenance bandwidth of memory maintenance operations.

In Example 14, the subject matter of one or any combination of Examples 11-13 optionally includes determining a reserved memory read bandwidth requirement and determining a read credit limit according to the reserved memory read bandwidth requirement; determining a reserved memory write bandwidth requirement and determining a write credit limit according to the reserved memory write bandwidth requirement; delaying a memory read command when an assigned credit for the memory read command would exceed the read credit limit; and delaying a memory write command when an assigned credit for the memory write command would exceed the write credit limit.

In Example 15, the subject matter of one or any combination of Examples 11-14 optionally includes resetting the tracking of credits used by memory commands when a new timed credit window begins.

In Example 16, the subject matter of Example 15 optionally includes queuing the memory command until a subsequent timed credit window.

In Example 17, the subject matter of one or any combination of Examples 11-16 optionally includes performing memory commands that are assigned a credit with a higher priority than memory commands that are not assigned a credit.

In Example 18, the subject matter of one or any combination of Examples 11-17 optionally includes scheduling memory commands during the timed credit window according to assigned credits for the memory commands, and scheduling the memory commands using round robin scheduling during the timed credit window when there are unused credits for the timed credit window.

In Example 19, the subject matter of one or any combination of Examples 11-18 optionally includes determining an available credit using the minimum bandwidth requirement and an available bandwidth of the memory device, and aborting the assigning the credits with an error when credits assigned exceeds the available credit.

Example 20 includes subject matter (such as a memory device) or can optionally be combined with one or any combination of Examples 1-19 to include such subject matter, comprising one or more memory components that include memory cells of a memory array and a memory controller operatively coupled to the one or more memory components. The memory controller is configured to determine credits assigned to types of memory commands received from a host system; accumulate the credits of memory commands performed during a timed credit window; perform a memory command during the timed credit window when the credits accumulated during the timed credit window are less than a specified credit limit; and delay performing the memory command when a credit assigned to the memory command would cause credits accumulated during the timed credit window to exceed the credit limit.

In Example 21, the subject matter of Example 20 optionally includes at least one memory command queue and a memory controller configured to reset a count of the accumulated credits when initiating a new timed credit window; and delay performing the memory command by queuing the memory command until a subsequent timed credit window.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

The above description is intended to be illustrative, and not restrictive. For example, the above-described examples (or one or more aspects thereof) may be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A computing system, comprising:
a memory device including:
a memory array including memory cells that are included in one or more memory components; and
a memory controller operatively coupled to the one or more memory components; and
a host device including a host processor configured to:
determine bandwidth requirements of types of memory commands according to read and write bandwidth requirements of the memory commands; and
determine a command bandwidth limit based on a reserved bandwidth requirement for the memory device and send the command bandwidth limit and determined bandwidth requirements to the memory controller;
wherein the memory controller is configured to:
perform a memory command when a bandwidth requirement of the memory command is within the command bandwidth limit; and
delay performing the memory command when the bandwidth requirement for the memory command exceeds the command bandwidth limit.

2. The computing system of claim 1, wherein the host processor is configured to:
assign credits to types of memory commands according to the read and write bandwidth requirements of the memory commands; and
determine a credit limit based on the reserved bandwidth requirement for the memory device and send the credit limit and assigned credits to the memory controller;
wherein the memory controller is configured to:
perform a memory command when an assigned credit of the memory command is within the credit limit; and
delay performing the memory command when the assigned credit for the memory command exceeds the credit limit.

3. The computing system of claim 2, wherein the memory controller is configured to:
accumulate credits of memory commands performed during a timed credit window;
perform a memory command during the timed credit window when the accumulated credits during the timed credit window are less than the credit limit; and
delay performing the memory command when an assigned credit for the memory command would cause credits accumulated during the timed credit window to exceed the credit limit.

4. The computing system of claim 3, including:
at least one memory command queue included in the memory device;
wherein the memory controller is configured to:
set the accumulated credits to zero when a new timed credit window begins; and
delay performing the memory command by queuing the memory command until a subsequent timed credit window begins.

5. The computing system of claim 3, wherein the memory controller is configured to:
schedule performing the memory commands during the timed credit window according to the assigned credits when the memory commands have assigned credit; and
schedule performing the memory commands according to round robin scheduling during the timed credit window when credit is unused during the timed credit window.

6. The computing system of claim 2, wherein the host processor is configured to:
set the credit limit to less than or equal to the reserved bandwidth requirement for the memory system; and
assign a credit to a type of memory command that is a fraction of an available bandwidth of the memory system.

7. The computing system of claim 2, wherein the host processor is configured to include a maintenance bandwidth of memory maintenance operations in the determined reserved bandwidth requirement.

8. The computing system of claim 2,
wherein the host processor is configured to:
determine a reserved memory read bandwidth requirement and determine a read credit limit according to the reserved memory read bandwidth requirement; and
determine a reserved memory write bandwidth requirement and determine a write credit limit according to the reserved memory write bandwidth requirement; and
wherein the memory controller is configured to:
delay a memory read command when an assigned credit for the memory read command would exceed the read credit limit; and
delay a memory write command when an assigned credit for the memory write command would exceed the write credit limit.

9. The computing system of claim 2, wherein the memory controller is configured to perform memory commands that are assigned credit with a higher priority than memory commands that are not assigned credit.

10. The computing system of claim 2, wherein the host device is configured to:
determine application layer bandwidth requirements; and
allocate the credits to memory commands using the application layer bandwidth requirements and a bandwidth capability of the memory device.

11. A method of operating a computing system, the method comprising:
determining, by a host device of the computing system, a reserved bandwidth requirement for a memory device of the computing system;
assigning credits to types of memory commands according to read and write bandwidth used by the memory commands;
tracking, by a memory controller of the memory device, credits accumulated by memory commands performed during a timed credit window;
performing a memory command during the timed credit window when the credits accumulated during the timed credit window is less than a credit limit, wherein the credit limit is determined according to the reserved bandwidth requirement; and
delaying the memory command when an assigned credit for the memory command causes the credits accumulated during the timed credit window to exceed the credit limit.

12. The method of claim 11, including:
setting the credit limit to less than or equal to the reserved bandwidth requirement for the memory device; and
wherein the assigning credits includes assigning a credit that is a fraction of an available bandwidth of the memory device.

13. The method of claim 11, wherein the determining the reserved bandwidth requirement includes determining the reserved bandwidth requirement to include a maintenance bandwidth of memory maintenance operations.

14. The method of claim 11,
wherein the determining the reserved bandwidth requirement includes:
determining a reserved memory read bandwidth requirement and determining a read credit limit according to the reserved memory read bandwidth requirement; and
determining a reserved memory write bandwidth requirement and determining a write credit limit according to the reserved memory write bandwidth requirement; and
wherein the delaying the memory command includes:
delaying a memory read command when an assigned credit for the memory read command would exceed the read credit limit; and
delaying a memory write command when an assigned credit for the memory write command would exceed the write credit limit.

15. The method of claim 11, including resetting the tracking of credits used by memory commands when a new timed credit window begins.

16. The method of claim 15, wherein delaying the memory command includes queuing the memory command until a subsequent timed credit window.

17. The method of claim 11, including performing memory commands that are assigned a credit with a higher priority than memory commands that are not assigned a credit.

18. The method of claim 11, including:
scheduling memory commands during the timed credit window according to assigned credits for the memory commands; and
scheduling the memory commands using round robin scheduling during the timed credit window when there are unused credits for the timed credit window.

19. The method of claim 11, including:
determining an available credit using the reserved bandwidth requirement and an available bandwidth of the memory device; and
aborting the assigning the credits with an error when credits assigned exceeds the available credit.

20. A memory device comprising:
one or more memory components that include memory cells of a memory array; and
a memory controller operatively coupled to the one or more memory components, wherein the memory controller is configured to:
determine credits assigned to types of memory commands received from a host system;
accumulate the credits of memory commands performed during a timed credit window;
perform a memory command during the timed credit window when the credits accumulated during the timed credit window are less than a specified credit limit; and
delay performing the memory command when a credit assigned to the memory command would cause credits accumulated during the timed credit window to exceed the credit limit.

21. The memory device of claim 20, including:
at least one memory command queue; and
wherein the memory controller is configured to:
reset a count of the accumulated credits when initiating a new timed credit window; and
delay performing the memory command by queuing the memory command until a subsequent timed credit window.
